(19) United States
(12) Patent Application Publication
(10) Pub. No.: US 2026/0044939 A1
(43) Pub. Date: Feb. 12, 2026

(54) JOINT PROBABILITY DETERMINATION FOR DETECTION SYSTEM

(71) Applicant: GM Global Technology Operations LLC, Detroit, MI (US)

(72) Inventors: Roy Uziel, Bat Yam (IL); Oded Bialer, Petach Tikva (IL)

(73) Assignee: GM Global Technology Operations LLC, Detroit, MI (US)

(21) Appl. No.: 18/801,172

(22) Filed: Aug. 12, 2024

(51) Int. Cl. G06T 5/70; G06T 5/60; G06V 20/56

(52) U.S. Cl. CPC G06T 5/70; G06T 5/60; G06V 20/56; G06T 2207/20081; G06T 2207/20084

(57) ABSTRACT

A computer-implemented method when executed by data processing hardware causes the data processing hardware to perform operations. The operations include training, based on a training distribution of a prediction model, a denoiser, the denoiser being a neural network, receiving an original distribution set including an image and image annotations, and executing, on the image and the image annotations, forward diffusion to define a noisy distribution set including a noisy image and noisy image annotations. The operations also include cleaning, by the trained denoiser, the noisy distribution set to define a cleaned distribution set including a cleaned image and cleaned image annotations, determining, based on a comparison of the cleaned distribution set with the original distribution set, a denoiser loss value, and generating, based on the denoiser loss value, a joint probability.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to determining a joint probability for a detection system. Specifically, determining a joint probability for a detection system of a vehicle.

Many standard imaging modules are trained using manually input images, which include manual annotations on the images. These images are gathered by a team and manually annotated to label and identify objects of interest within the image. The images, including the manual annotations, are then uploaded to a system for training the imaging module. While effective, the manual annotations are time intensive and inefficient. Thus, an improved method of training the imaging system and obtaining relative probability between the image and annotations is needed.

### SUMMARY

In some aspects, a computer-implemented method when executed by data processing hardware causes the data processing hardware to perform operations. The operations include training, based on a training distribution of a prediction model, a denoiser, the denoiser being a neural network, receiving an original distribution set including an image and image annotations, and executing, on the image and the image annotations, forward diffusion to define a noisy distribution set including a noisy image and noisy image annotations. The operations also include cleaning, by the trained denoiser, the noisy distribution set to define a cleaned distribution set including a cleaned image and cleaned image annotations, determining, based on a comparison of the cleaned distribution set with the original distribution set, a denoiser loss value, and generating, based on the denoiser loss value, a joint probability.

In some implementations, the operations may also include defining a loss value threshold, comparing the joint probability with the loss value threshold, and executing, based on the joint probability being greater than the loss value threshold, a response, the response including at least one of an action and an alert. Optionally, the operations may include modifying, in response to the joint probability, the image annotations, executing, at the modified image annotations, a search, and adapting, based on the executed search, the image annotations. In other instances, the operations may include receiving, at the trained denoiser, a second noisy distribution set, cleaning, by the trained denoiser, the second noisy distribution set, generating, from the second noisy distribution set, a synthetic image and a synthetic segmentation, and updating, with the generated synthetic image and the generated synthetic segmentation, the training distribution of the prediction model. Optionally, generating the synthetic image and the synthetic image segmentation may include extracting, from the synthetic image segmentation, synthetic image annotations.

In some instances, training the denoiser may include providing the denoiser a plurality of pairs of images and image annotations, the plurality of pairs of images and image annotations each having additive noise with different noise variances, predicting, via the denoiser, the additive noise at different noise variances, comparing the added noise with the predicted noise to determine an error, and adapting parameters of the neural network of the denoiser to reduce the error between the added noise and the predicted noise. In some examples, executing the forward diffusion on the image annotations may include converting the image annotations into a segmentation map and applying, at the segmentation map, noise to define a noisy segmentation map including the noisy image annotations. Optionally, cleaning the noisy distribution set may include executing the image denoiser and the segmentation denoiser and generating, from each of the image denoiser and the segmentation denoiser, a loss function. The operations may further include training, based on the loss function, the prediction model.

In other aspects, a detection system for a vehicle includes data processing hardware and memory hardware in communication with the data processing hardware. The memory hardware includes instructions that when executed on the data processing hardware cause the data processing hardware to perform operations. The operations include training, based on a training distribution of a prediction model, a denoiser, the denoiser being a neural network, receiving an original distribution set including an image and image annotations, executing, on the image the image annotations, forward diffusion to define a noisy distribution set including a noisy image and noisy image annotations, and cleaning, by the trained denoiser, the noisy distribution set to define a cleaned distribution set including a cleaned image and cleaned image annotations. The operations also include receiving, at the trained denoiser, a second noisy distribution set, generating, from the second noisy distribution set, a synthetic image and a synthetic segmentation, and updating, with the generated synthetic image and the generated synthetic segmentation, the training distribution of the prediction model. The operations further include determining, based on a comparison of the cleaned distribution set with the original distribution set, a denoiser loss value and generating, based on the denoiser loss value, a joint probability.

In some examples, the operations may include modifying, in response to the joint probability, the image annotations, executing, at the modified image annotations, a search, and adapting, based on the executed search, the image annotations. Optionally, generating the synthetic image and the synthetic image segmentation may include extracting, from the synthetic image segmentation, synthetic image annotations. In some instances, training the denoiser may include providing the denoiser a plurality of pairs of images and image annotations, the plurality of pairs of images and image annotations each having additive noise with different noise variances, predicting, via the denoiser, the additive noise at different noise variances, comparing the added noise with the predicted noise to determine an error, and adapting parameters of the neural network of the denoiser to reduce the error between the added noise and the predicted noise.

In other examples, cleaning the noisy image may include receiving, at the image denoiser, text inputs. Optionally, executing the forward diffusion on the image annotations may include converting the image annotations into a segmentation map and applying, at the segmentation map, noise to define a noisy segmentation map including the noisy image annotations. In some instances, cleaning the noisy distribution set may include executing the image denoiser and the segmentation denoiser, generating, from each of the image denoiser and the segmentation denoiser, a loss function, and training, based on the loss function, the prediction model. In some examples, converting the image annotations into the segmentation map may include identifying objects of interest on the segmentation map and classifying the objects into an object classification. Optionally, classifying the objects may include applying a gradient code to the identified objects of interest based on the object classification.

In yet another aspect, a detection system for a vehicle includes data processing hardware and memory hardware in communication with the data processing hardware. The memory hardware stores instructions that when executed on the data processing hardware cause the data processing hardware to perform operations. The operations include training, based on a training distribution of a prediction model, a denoiser, the denoiser being a neural network, receiving an original distribution set including an image and image annotations, and executing, on the image the image annotations, forward diffusion to define a noisy distribution set including a noisy image and noisy image annotations. The operations also include cleaning, by the trained denoiser, the noisy distribution set to define a cleaned distribution set including a cleaned image and cleaned image annotations, receiving, at the trained denoiser, a second noisy distribution set, and generating, from the second noisy distribution set, a synthetic image and a synthetic segmentation. The operations further include updating, with the generated synthetic image and the generated synthetic segmentation, the training distribution of the prediction model, determining, based on a comparison of the cleaned distribution set with the original distribution set, a denoiser loss value, defining a loss value threshold, comparing the denoiser loss value with the loss value threshold, executing, based on the denoiser loss value being greater than the loss value threshold, a response, the response including at least one of an action and an alert, and generating, based on the denoiser loss value, a joint probability.

In some examples, the operations may include modifying, in response to the joint probability, the image annotations, executing, at the modified image annotations, a search, and adapting, based on the executed search, the image annotations.

### BRIEF DESCRIPTION OF THE DRAWINGS

The drawings described herein are for illustrative purposes only of selected configurations and are not intended to limit the scope of the present disclosure.

FIG. 1 is a schematic of a vehicle configured with a detection system according to the present disclosure;

FIG. 2 is an exemplary block diagram of a detection system according to the present disclosure;

FIG. 3 is another exemplary block diagram of a detection system according to the present disclosure;

FIG. 4 is a schematic of a detection architecture according to the present disclosure executing a denoiser;

FIG. 5 is another schematic of a detection architecture according to the present disclosure executing a denoiser that receives a text input;

FIG. 6 is a schematic diagram of communication between an image denoiser and a segmentation denoiser according to the present disclosure;

FIG. 7 is a schematic of a denoiser according to the present disclosure, the denoiser configured to generate images; and

FIG. 8 is an example flow diagram of the detection system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

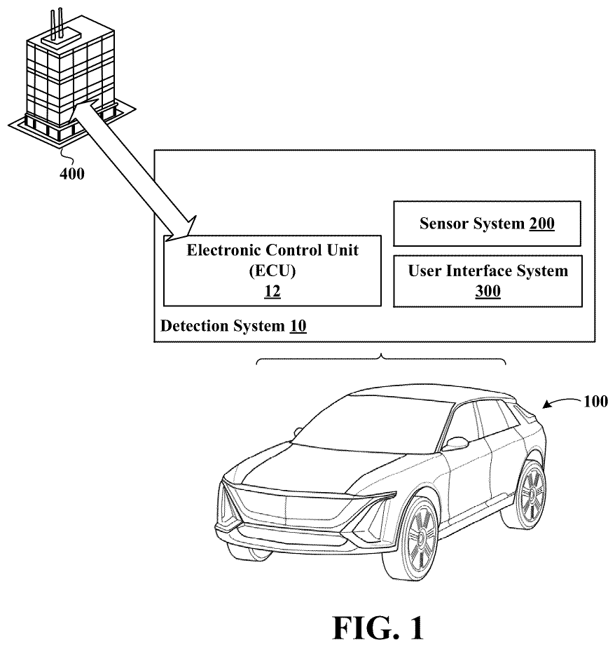

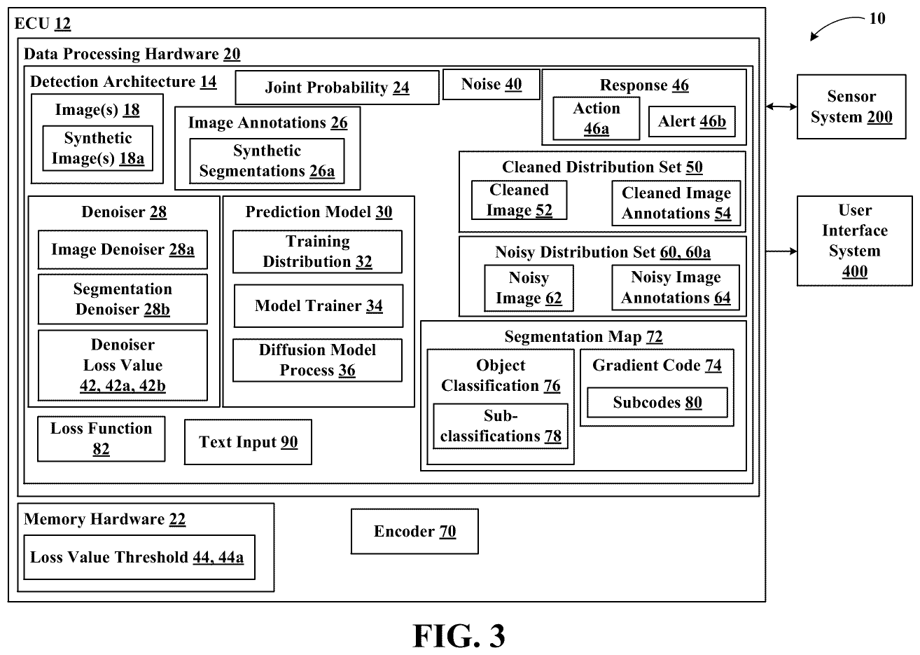

Referring to FIGS. 1-4, a detection system 10 for a vehicle 100 includes an electronic control unit (ECU) 12. The ECU 12 is configured with a detection architecture 14. The detection architecture 14 is configured to assist the detection system 10 in identifying objects of interest 16 in images 18. The images 18 may be received from a sensor system 200 of the vehicle 100 or may be communicated to the detection system 10 from a back-office server 300 or configured as part of the detection architecture 14 during initialization of the detection system 10. The detection architecture 14 is executed by data processing hardware 20 of the ECU 12, which is configured to perform operations, described herein. The ECU 12 also includes memory hardware 22 that is in communication with the data processing hardware 20. The memory hardware 22 stores instructions that, when executed on the data processing hardware 20, cause the data processing hardware 20 to perform the operations described herein.

During operation, the detection architecture 14 is configured to generate a joint probability 24 for an original distribution set 25 that includes the images 18 and image annotations 26. The joint probability 24 is determined through training and operation of a denoiser 28. A prediction model 30 is executed by the data processing hardware 20 to train the denoiser 28 and ultimately obtain the joint probability 24. The image annotations 26 may include, but are not limited to, bounding boxes on the images 18 and are generated based on a prediction model 30, described herein. The joint probability 24 is the probability that the image annotations 26 are correct relative to a training distribution 32 of the prediction model 30. For example, the joint probability 24 is calculated based on a probability of the image 18 and the image annotations 26.

Referring still to FIGS. 1-4, the denoiser 28 is trained using the training distribution 32 of the prediction model 30. The training distribution 32 is configured to assist the denoiser 28 in reducing noise 40 in images 18. The denoiser 28 includes a residual error or denoiser loss value 42 that is inversely proportional to the training distribution 28. The denoiser loss value 42 is determined based on a comparison of a cleaned distribution set 50 with the original distribution set 25, described in more detail below. The denoiser 28 is trained by the prediction model 30 to clean the noise 40 from a source image 18 and source image annotations 26. For example, the denoiser 28 may receive the source image 18 and the source image annotations 26 and the ECU 12 may execute forward diffusion to define a noisy distribution set 60 including a noisy image 62 and noisy image annotations 64. The denoiser 28, as part of the training, cleans the noisy distribution set 60 to define the cleaned distribution set 50. The cleaned distribution set 50 includes a cleaned image 52 and cleaned image annotations 54. As mentioned above, the cleaned distribution set 50 is compared with the training distribution 32 to identify the denoiser loss value 42.

The denoiser loss value 42 is inversely proportional to the joint probability 24, such that the joint probability 24 can be generated by taking the inverse of the denoiser loss value 42. The detection system 10 is configured to detect the objects of interest 16, mentioned above, in the images 18. The objects of interest 16 are annotated and identified as part of the image annotations 26. The joint probability 24 provides the detection system 10 with a mechanism for assessing the accuracy of detected objects of interest 16. For example, if the joint probability 24 has a high value (i.e., high degree of matching between the image 18 and the image annotations 26), then the detected objects of interest 16 are accurate. Conversely, if the joint probability 24 has a low value, the joint probability 24 may indicate an error between the image 18 and the image annotations 26.

Referring still to FIGS. 1-4, the detection architecture 14 is configured with the prediction model 30, which is configured with a model trainer 34 and is communicatively coupled with the denoiser 28. The denoiser 28 may include a neural network. For instance, the model trainer 34 may map the training distribution 32 to output data (e.g., the cleaned distribution set 60) to generate the neural network 28. Generally, the model trainer 34 generates hidden nodes, weights of connections between hidden nodes and input nodes that correspond with the training distribution 32, and weights of connections between layers of the hidden nodes themselves. Thereafter, the fully trained neural network 28 may be employed against input data (e.g., the images 18 and image annotations 26) to generate unknown output data (e.g., joint probability 24). In some examples, the neural network 28 is a deep neural network (e.g., a regressor deep neural network) that has a first hidden layer and a second hidden layer. For example, the first hidden layer may have sixteen nodes and the second hidden layer may have eight nodes. The model trainer 34 typically trains the denoiser 28 in batches. That is, a denoiser 28 is typically trained on a group of input parameters (e.g., the training distribution 32, the noisy distribution set 60, and the cleaned distribution set 50) at a time.

As part of the training, the denoiser 28 may receive increasingly noisy distribution sets 60, and the denoiser 28 cleans each noisy distribution set 60 sequentially. For example, during the training process, the noisy distribution set 60 may receive a progressive increased amount of noise. The denoiser 28 improves the cleaning process through the repeated executions by feeding the denoiser loss value 42 to the prediction model 30. For example, the image 18 and image annotations 26 may be generated through multiple denoising steps that gradually clean the image 18 and the image annotations 26. Additionally or alternatively, the cleaning may be accomplished in a single denoising step. The model trainer 34 may utilize the iterations of the denoiser loss value 42 to train the denoiser 28 to better identify the objects of interest 16 during the cleaning process. As a result of the training, the denoiser 28 has a high joint probability 24 when the cleaned distribution set 50 is compared with the training distribution 32. If there is a low joint probability 24 between the image annotations 26 and the image 18, there is an error in the detection.

The denoiser 28 is trained to reduce the noise 40 in the image 18 through the cleaning process. During training, the noise 40 added is known by the detection architecture 14, such that the cleaning process is used to evaluate the effectiveness of the denoiser 28. Thus, the detection architecture 14 can test the denoiser 28 on the cleaning process by feeding different levels of noise 40 and evaluating the resultant cleaned distribution set 50.

The resultant denoiser loss value 42 is inversely proportional to the likelihood that the cleaned distribution set 50 is from the training distribution 32. The likelihood of the cleaned distribution set 50 coming from the training distribution 32 is the joint probability 24. Thus, the denoiser 28 is trained on the training distribution 32, and the detection architecture 14 may measure the denoiser loss value 42 for a given sample. The detection architecture 14 may then obtain the joint probability 24 that the image 18 is from the training distribution 32 by calculating the inverse of the denoiser loss value 42. Each iteration of noisy distribution sets 60 that are cleaned and compared with the training distribution 32 may be incorporated as part of the training distribution 32 to continually train and improve the ability of the denoiser 28 to clean images 18 and identify accurate image annotations 26.

For example, the denoiser 28 may be trained with thousands of pairs of examples where the image annotations 26 are correct with a respective image 18. The denoiser 28 is trained to clean the noise 40 of the image 18 and the image annotations 26. The joint probability 24 generation is improved by an increased amount of training of the denoiser 28, as the denoiser 28 improves in accurately identifying the image annotations 26 in the respective images 18 through increased training sessions.

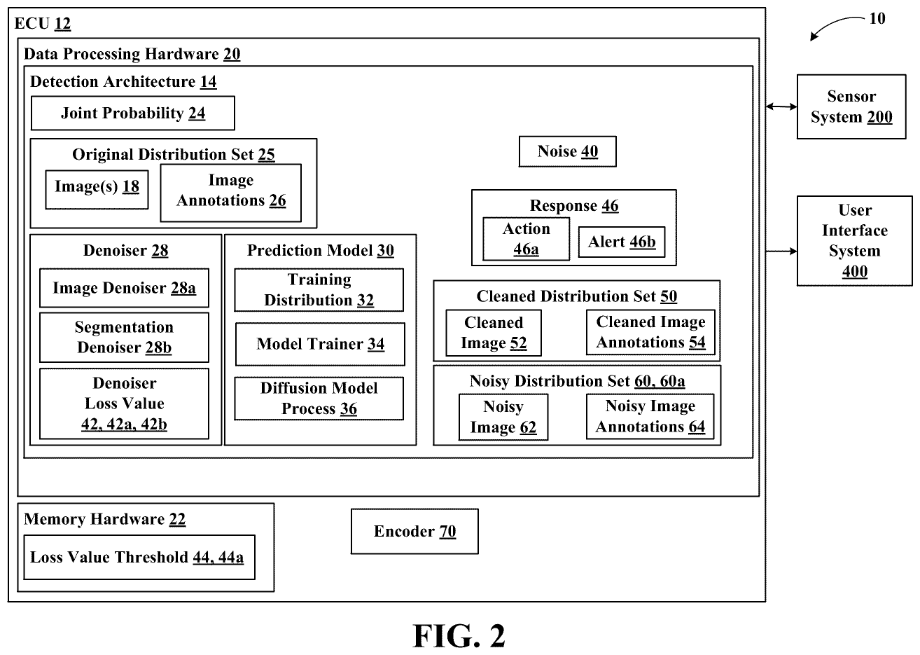

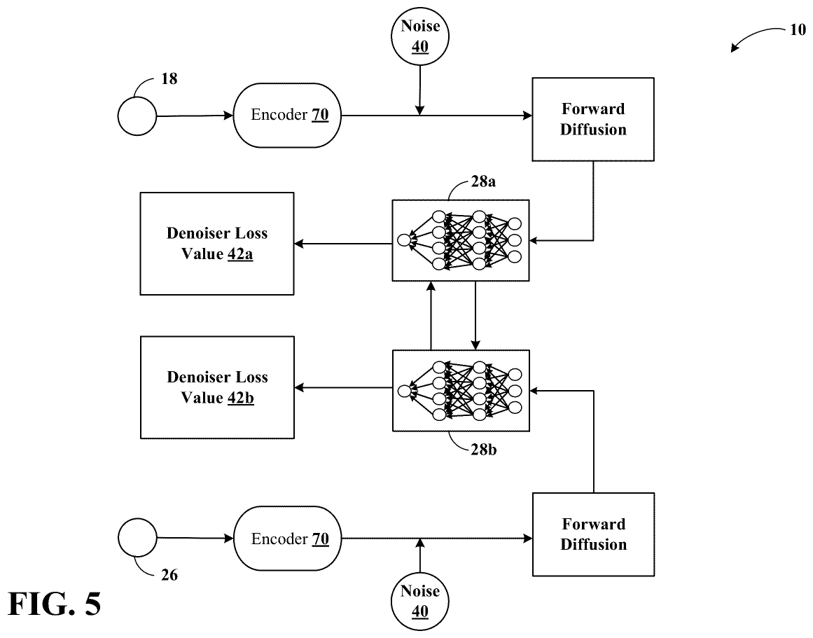

Referring now to FIGS. 2-5, the detection architecture 14 may include a loss value threshold 44, which may be stored in the memory hardware 22 of the ECU 12. The detection architecture 14 compares the denoiser loss value 42 with the loss value threshold 44. Additionally or alternatively, the detection architecture 14 may compare the joint probability 24 with the loss value threshold 44, as the joint probability 24 is inversely proportional to the denoiser loss value 42. If the denoiser loss value 42 is greater than the loss value threshold 44, then an error is flagged. Additionally or alternatively, if the joint probability 24 is lower than the loss value threshold 44, then an error is flagged. Regardless of which value is compared with the loss value threshold 44, if an error is flagged, then the detection architecture 14 may execute a response 46. The response 46 may include at least one of an action 46a and an alert 46b.

For example, the action 46a of the response 46 may include slowing down the vehicle 100 (FIG. 1) and/or applying additional power to the sensor system 200. It is contemplated that other practicable actions 46a may be executed as the response 46 depending on the degree to which the denoiser loss value 42 exceeds the loss value threshold 44. The alert 46b may be displayed on a user interface system 400. The alert 46b may indicate a confidence level of the detection system 10 and may provide a user with enhanced levels of caution as a result.

With further reference to FIGS. 2-5, the detection architecture 14 may utilize the joint probability 24 to improve detections by the detection system 10. For example, the detection architecture 14 may modify the image annotations 26 in response to the denoiser loss value 42. If the denoiser loss value 42 is high, then the detection architecture 14 may execute a search over the image annotations 26. The detection architecture 14 may then adapt the image annotations 26 based on the executed search to reduce the denoiser loss value 42. For example, the detection architecture 14 may repeatedly modify the image annotations 26 and execute the search until the denoiser loss value 42 is minimal. The modified image annotations 26 advantageously assist refining the denoiser 28, which ultimately results in refined detections.

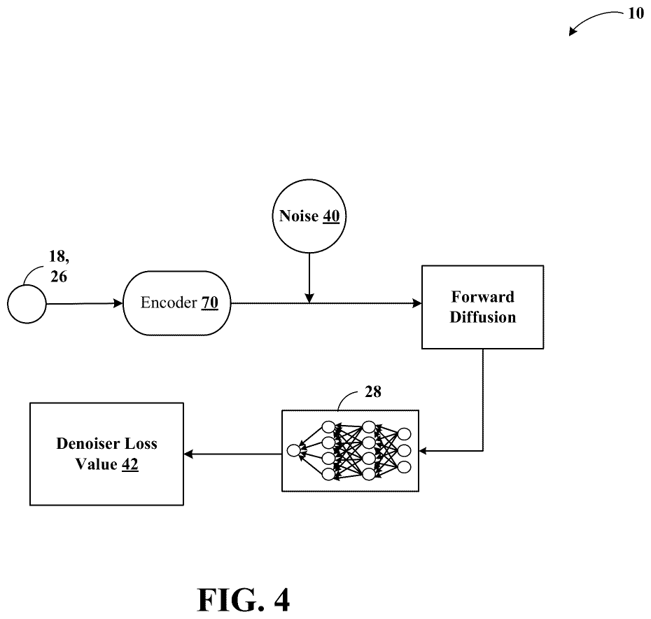

In some examples, the denoiser 28 is a joint denoiser 28 and includes an image denoiser 28a and a segmentation denoiser 28b. As illustrated in FIG. 4, the image 18 and the image annotations 26 may be compressed via an encoder 70 to reduce the image 18 and image annotations 26. In other examples, the image 18 and the image annotations 26 may remain uncompressed. The image 18 and the image annotations 26 may then proceed through the forward diffusion process and a noisy image 62 and noisy image annotations 64 are produced. For example, during the forward diffusion process, noise 40 is added to each of the image 18 and the image annotations 26, which results in the noisy distribution set 60. It is contemplated that the image annotations 26 may be referred to as segmentations 26, such that the segmentation denoiser 28b is configured to denoise the noisy segmentations 64.

During the forward diffusion of the segmentations 26, the segmentations 26 are converted into a segmentation map 72. The forward diffusion process also applies the noise 40 to the segmentation map 72 to define a noisy segmentation map 72a, which includes the noisy image annotations 64. The segmentation map 72 is configured with a gradient code 74. The detection architecture 14 may identify objects of interest 16 along the segmentation map 72 and classify the objects of interest 16 into an object classification 76. The gradient code 74 is applied to the objects of interest 16 based on the object classification 76. For example, different objects of interest 16 may have a different gradient code 74 depending on the object classification 76, such that objects of interest 16 in the same object classification 76 may have the same or similar gradient codes 74. The gradient code 74 may be visualized using a grayscale or color coding system. For example, pedestrians may have a gradient code 74 of red and vehicles may have a gradient code 74 of blue. Within each object classification 76, there may be subclassifications 78 corresponding to subcodes 80 of the gradient code 74. For example, if pedestrians have a gradient code 74 of red, then child pedestrians may have a different red subcode 80 as compared to an adult pedestrian. The subcodes 80 may be expressed as a different shade of the gradient code 74 and/or may be a different color within the same gradient code 74 family (i.e., family of red including pink, salmon, maroon, crimson, etc.). Thus, the gradient codes 74 and subcodes 80 may be utilized to distinguish between different types of objects of interest 16.

Referring still to FIGS. 2-5, the detection architecture 14 calculates the residual noise 40 between the noisy image 62 and the estimated cleaned image 52 and generates a loss function 82 from each of the image denoiser 28a and the segmentation denoiser 28b. The detection architecture 14 utilizes the loss function 82 to further train the prediction model 30 and, thus, train the parameters of the denoiser 28. If the denoisers 28a, 28b have executed the cleaning process effectively, then the joint probability 24 is high and the loss function 82 is low.

The detection architecture 14 also executes cleaning process and comparison, described above, for the noisy image annotations 64 (i.e., noisy segmentations 64) and the cleaned image annotations 54 output by the segmentation denoiser 28b. The resultant segmentation denoiser loss value 42b is communicated with the image denoiser 28a, which has an image denoiser loss value 42a. Each of the loss values 42a, 42b collectively define the loss function 82, which is used to determine the joint probability 24, as described above. Thus, if the loss function 82 is low, then the joint probability 24 is high, meaning it is likely that the image 18 and image annotations 26 match the training distribution 32. The denoiser 28 may also receive a text input 90 that describes the image 18. For example, the text input 90 may indicate, but is not limited to, weather conditions present in the image 18 that may add additional noise 40. The denoiser 28 may utilize the text input 90 to improve the cleaning of the image 18.

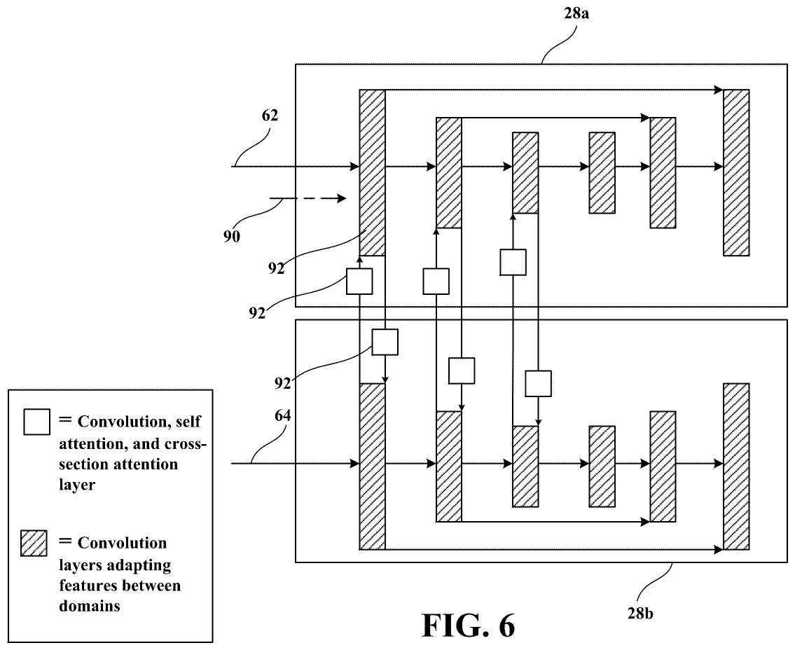

With specific reference to FIG. 6, the image denoiser 28a and the segmentation denoiser 28b are illustrated as a schematic chart. Each of the image denoiser 28a and the segmentation denoiser 28b have a unit architecture, such as a standard neural network architecture (described above). Each denoiser 28a, 28b includes a plurality of layers 92 that include a convolution layer, self-attention layer, and a cross-attention layer. The denoisers 28a, 28b exchange the convolution layers that include adapting features between domains of the denoisers 28a, 28b. The convolution layers 92 represent the sharing of information between the denoisers 28a, 28b, such that each layer 92 is used as an input sum in the corresponding layer in the receiving denoiser 28a, 28b. While the denoisers 28a, 28b are described and illustrated, it is also contemplated that the functions described herein may be executed by a singular denoiser 28.

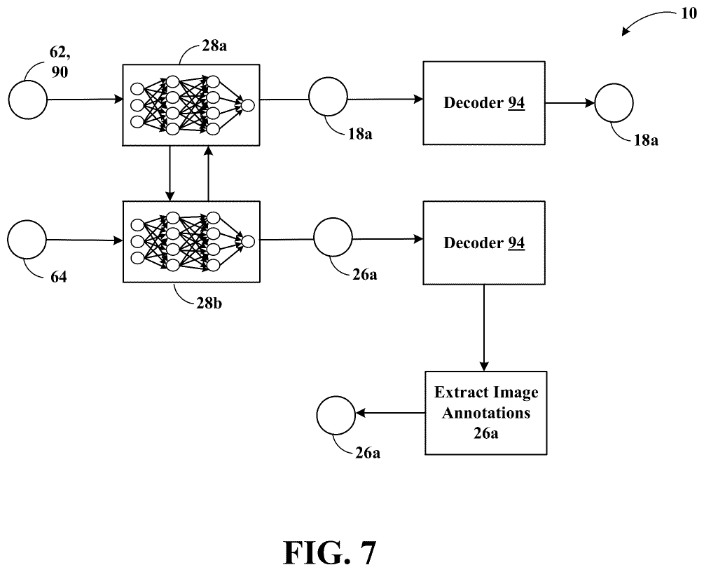

With reference to FIGS. 2-7, the detection architecture 14 may be further utilized to generate synthetic images 18a with corresponding synthetic segmentations 26a using a provided noisy distribution set 60a. For example, a noisy distribution set 60a may be provided to the trained denoiser 28, which may execute a diffusion model process 36. The diffusion model process 36 includes, during training, incrementally adding noise to the image 18 from the training distribution 32 and executing the cleaning process until the image 18 provided is complete noise 40. Once the image 18 is complete noise 40, the denoiser 28 is trained to generate a synthetic image 18a that includes corresponding synthetic segmentations 26a. Thus, if the detection architecture has an image 18, but does not have image annotations 26 for that image, then the detection architecture 14 can execute the diffusion model process 36 to obtain the synthetic image 18a, based on the original image 18, and the corresponding synthetic segmentations 26a.

In some examples, the detection architecture 14 may sample a random image 18 (i.e., an image 18 outside of the training distribution 32), add noise 40 to the random image 18, and provide the noisy image 62 to the denoiser. The denoiser 28 is configured to execute the diffusion model process 36 and, through multiple iterations of cleaning and adding noise 40, generate the synthetic image 18a and corresponding synthetic segmentations 26a.

The synthetic segmentations 26a may subsequently be used to extract the image annotations 26 as a result of the synthetic segmentations 26a. In some examples, the image denoiser 28a and the segmentation denoiser 28b cooperate by sharing data to assist one another in cleaning the noisy image 62 and noisy segmentation 64 and passing the cleaned image 52 and cleaned segmentations 54 through a decoder 94 to synthesize the synthetic images 18a and the synthetic segmentations 26a. To generate the synthetic image 18a and synthetic segmentation 26a, the denoisers 28a, 28b learn how to clean the noisy image 62 and noisy segmentation 64 based on the noise 40. The training distribution 32 is updated with the synthetic image 18a and synthetic image annotations 26a, such that future iterations of noise 40 application may be used to generate additional images 18a from an increased amount of noise 40.

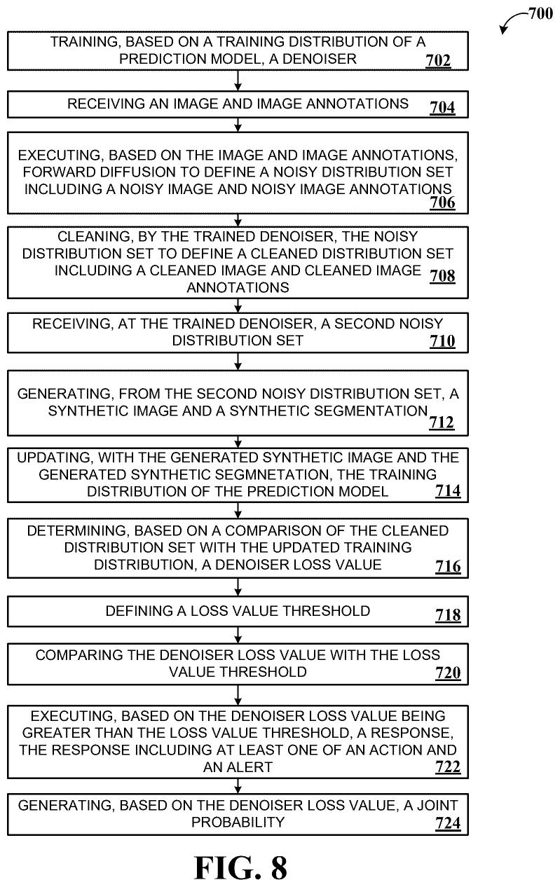

Referring now to FIGS. 1-8, an exemplary flow diagram of a method 700 for the detection system 10 is illustration. A denoiser 28 is trained, at 702, based on a training distribution 32 of a prediction model 30. At 704, an image 18 and image annotations 26 are received. At 706, the detection system 10 executes, based on the image and image annotations, forward diffusion to define a noisy distribution set 60 including a noisy image 62 and noisy image annotations 64. The detection system 10 cleans, at 708, the noisy distribution set 60 by the trained denoiser 28 to define a cleaned distribution set 50 including a cleaned image 52 and cleaned image annotations 54. At 710, the trained denoiser 28 receives a second noisy distribution set 60a. The detection system 10, at 712, generates a synthetic image 18a and a synthetic segmentation 26a from the second noisy distribution set 60a.

The detection system 10 updates, at 714, the training distribution 32 of the prediction model 30 with the generated synthetic image 18a and the generated synthetic segmentation 26a. The detection system 10 determines, at 716, a denoiser loss value 42 based on a comparison of the cleaned distribution set 50 and the updated training distribution 32. A loss value threshold 44 is defined, at 718, and the denoiser loss value 42 is compared with the loss value threshold 44, at 720. The detection system 10 executes, at 722, a response 46 based on the denoiser loss value 42 being greater than the loss value threshold 44. The response 46 includes at least one of an action 46a and an alert 46b. The detection system 10 ultimately generates, at 724, a joint probability 24 based on the denoiser loss value 42.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
training, based on a training distribution of a prediction model, a denoiser, the denoiser being a neural network;
receiving an original distribution set including an image and image annotations;
executing, on the image and the image annotations, forward diffusion to define a noisy distribution set including a noisy image and noisy image annotations;
cleaning, by the trained denoiser, the noisy distribution set to define a cleaned distribution set including a cleaned image and cleaned image annotations;
determining, based on a comparison of the cleaned distribution set with the original distribution set, a denoiser loss value; and
generating, based on the denoiser loss value, a joint probability.

2. The method of claim 1, further including:
defining a loss value threshold;
comparing the joint probability with the loss value threshold; and
executing, based on the joint probability being greater than the loss value threshold, a response, the response including at least one of an action and an alert.

3. The method of claim 1, further including:
modifying, in response to the joint probability, the image annotations;
executing, at the modified image annotations, a search; and
adapting, based on the executed search, the image annotations.

4. The method of claim 1, further including:
receiving, at the trained denoiser, a second noisy distribution set;
cleaning, by the trained denoiser, the second noisy distribution set;
generating, from the second noisy distribution set, a synthetic image and a synthetic segmentation; and
updating, with the generated synthetic image and the generated synthetic segmentation, the training distribution of the prediction model.

5. The method of claim 4, wherein generating the synthetic image and the synthetic image segmentation includes extracting, from the synthetic image segmentation, synthetic image annotations.

6. The method of claim 1, wherein training the denoiser includes:
providing the denoiser a plurality of pairs of images and image annotations, the plurality of pairs of images and image annotations each having additive noise with different noise variances;
predicting, via the denoiser, the additive noise at different noise variances;
comparing the added noise with the predicted noise to determine an error; and
adapting parameters of the neural network of the denoiser to reduce the error between the added noise and the predicted noise.

7. The method of claim 1, wherein executing the forward diffusion on the image annotations includes converting the image annotations into a segmentation map and applying, at the segmentation map, noise to define a noisy segmentation map including the noisy image annotations.

8. The method of claim 7, wherein cleaning the noisy distribution set includes executing the image denoiser and the segmentation denoiser and generating, from each of the image denoiser and the segmentation denoiser, a loss function.

9. The method of claim 8, further including training, based on the loss function, the prediction model.

10. A detection system for a vehicle, the detection system comprising:
data processing hardware; and
memory hardware in communication with the data processing hardware, the memory hardware storing instructions that when executed on the data processing hardware cause the data processing hardware to perform operations comprising:
training, based on a training distribution of a prediction model, a denoiser, the denoiser being a neural network;
receiving an original distribution set including an image and image annotations;
executing, on the image the image annotations, forward diffusion to define a noisy distribution set including a noisy image and noisy image annotations;
cleaning, by the trained denoiser, the noisy distribution set to define a cleaned distribution set including a cleaned image and cleaned image annotations;
receiving, at the trained denoiser, a second noisy distribution set;
generating, from the second noisy distribution set, a synthetic image and a synthetic segmentation;
updating, with the generated synthetic image and the generated synthetic segmentation, the training distribution of the prediction model;
determining, based on a comparison of the cleaned distribution set with the original distribution set, a denoiser loss value; and
generating, based on the denoiser loss value, a joint probability.

11. The detection system of claim 10, further including:
modifying, in response to the joint probability, the image annotations;
executing, at the modified image annotations, a search; and
adapting, based on the executed search, the image annotations.

12. The detection system of claim 10, wherein generating the synthetic image and the synthetic image segmentation includes extracting, from the synthetic image segmentation, synthetic image annotations.

13. The detection system of claim 10, wherein training the denoiser includes:
providing the denoiser a plurality of pairs of images and image annotations, the plurality of pairs of images and image annotations each having additive noise with different noise variances;
predicting, via the denoiser, the additive noise at different noise variances;
comparing the added noise with the predicted noise to determine an error; and
adapting parameters of the neural network of the denoiser to reduce the error between the added noise and the predicted noise.

14. The detection system of claim 13, wherein cleaning the noisy image includes receiving, at the image denoiser, text inputs.

15. The detection system of claim 13, wherein executing the forward diffusion on the image annotations includes converting the image annotations into a segmentation map and applying, at the segmentation map, noise to define a noisy segmentation map including the noisy image annotations.

16. The detection system of claim 15, wherein cleaning the noisy distribution set includes:
executing the image denoiser and the segmentation denoiser;
generating, from each of the image denoiser and the segmentation denoiser, a loss function; and
training, based on the loss function, the prediction model.

17. The detection system of claim 15, wherein converting the image annotations into the segmentation map includes identifying objects of interest on the segmentation map and classifying the objects into an object classification.

18. The detection system of claim 17, wherein classifying the objects includes applying a gradient code to the identified objects of interest based on the object classification.

19. A detection system for a vehicle, the detection system comprising:
data processing hardware; and
memory hardware in communication with the data processing hardware, the memory hardware storing instructions that when executed on the data processing hardware cause the data processing hardware to perform operations comprising:
training, based on a training distribution of a prediction model, a denoiser, the denoiser being a neural network;
receiving an original distribution set including an image and image annotations;
executing, on the image the image annotations, forward diffusion to define a noisy distribution set including a noisy image and noisy image annotations;
cleaning, by the trained denoiser, the noisy distribution set to define a cleaned distribution set including a cleaned image and cleaned image annotations;
receiving, at the trained denoiser, a second noisy distribution set;
generating, from the second noisy distribution set, a synthetic image and a synthetic segmentation;
updating, with the generated synthetic image and the generated synthetic segmentation, the training distribution of the prediction model;
determining, based on a comparison of the cleaned distribution set with the original distribution set, a denoiser loss value;
defining a loss value threshold;
comparing the denoiser loss value with the loss value threshold;
executing, based on the denoiser loss value being greater than the loss value threshold, a response, the response including at least one of an action and an alert; and
generating, based on the denoiser loss value, a joint probability.

20. The detection system of claim 19, further including:
modifying, in response to the joint probability, the image annotations;
executing, at the modified image annotations, a search; and
adapting, based on the executed search, the image annotations.
